(19) United States
(12) Patent Application Publication
(10) Pub. No.: US 2025/0170561 A1
(43) Pub. Date: May 29, 2025

(54) PEROVSKITE CATALYST, AND PREPARATION METHOD AND USE THEREOF IN ELECTROMAGNETIC DEGRADATION OF ORGANIC WASTE

(71) Applicants: Nankai University, Tianjin (CN); Kashi University, Kashi City (CN); Tianjin Sinotech Environmental Technology Development Co., Ltd., Tianjin (CN)

(72) Inventors: Weizun LI, Tianjin (CN); Mingyan YU, Tianjin (CN); Tao SUN, Tianjin (CN); Zhentong LIU, Tianjin (CN); Xianghao ZHA, Tianjin (CN)

(73) Assignees: Nankai University, Tianjin (CN); Kashi University, Kashi City (CN); Tianjin Sinotech Environmental Technology Development Co., Ltd., Tianjin (CN)

(21) Appl. No.: 18/405,006

(22) Filed: Jan. 5, 2024

(30) Foreign Application Priority Data
Nov. 23, 2023 (CN) 2023115714164

(51) Int. Cl. B01J 23/00; B01J 37/00; B01J 37/10

(52) U.S. Cl. CPC B01J 23/002; B01J 37/0018; B01J 37/10

(57) ABSTRACT

Provided are a perovskite catalyst, and a preparation method and use thereof in electromagnetic degradation of an organic waste. In the preparation method of the perovskite catalyst, the perovskite catalyst is prepared by co-precipitation. A precursor with a higher purity is prepared by limiting types, concentrations, and addition ratios of reaction raw materials as well as controlling a temperature and a pH value of the precipitation reaction, and provides a desirable basis for the preparation of a subsequent catalyst. The precursor is subjected to aging and calcination to obtain the perovskite catalyst.

### CROSS REFERENCE TO RELATED APPLICATION

This patent application claims the benefit and priority of Chinese Patent Application No. 2023115714164 filed with the China National Intellectual Property Administration on Nov. 23, 2023, the disclosure of which is incorporated by reference herein in its entirety as part of the present application.

### TECHNICAL FIELD

The present disclosure relates to the technical field of catalysts, and in particular to a perovskite catalyst, and a preparation method and use thereof in electromagnetic degradation of an organic waste.

### BACKGROUND

Currently, bottlenecks and problems existing in rural domestic waste treatment are mainly caused by incomplete infrastructure construction and high investment costs. Nowadays, a three-level treatment model of “village collection, township transfer, and county treatment” has been formed. However, with regard to the existing waste collection and treatment model, the waste incineration facilities could not operate normally due to the high transportation and collection costs of rural domestic waste and the small amount of waste generated although there are 5 t/d waste incineration facilities. The landfill method occupies a large amount of land resources, and there is a high cost of leakage prevention and leachate treatment. The government still supports the reduction of landfill treatment, and therefore direct landfill of domestic waste is no longer suitable for the current social development in China.

The degradation of organic waste by electromagnetic field technology could alleviate the bottlenecks and problems existing in rural domestic waste treatment to a certain extent. Although electromagnetic field technology degradation of organic waste reduces a degradation temperature of waste treatment, there is still a relatively high degradation temperature in the existing technology, generally 300° C. Moreover, dioxins are produced at the high degradation temperature, causing serious damage to the human respiratory system.

Therefore, it has become an urgent technical problem in this field to be solved to further reduce the temperature of electromagnetic degradation of organic waste so as to avoid the generation of dioxins.

### SUMMARY

The present disclosure is intended to provide a perovskite catalyst, and a preparation method and use thereof in electromagnetic degradation of an organic waste. In the present disclosure, the perovskite catalyst could reduce a temperature of the electromagnetic degradation of the organic waste, thereby avoiding the generation of dioxins.

To achieve the above objects, the present disclosure provides the following technical solutions.

The present disclosure provides a method for preparing a perovskite catalyst, including the following steps:
(1) mixing potassium nitrate, magnesium nitrate, calcium nitrate, and a binder with water to obtain a mixed solution;
(2) mixing the mixed solution obtained in step (1) with a sodium hydroxide solution, and conducting precipitation reaction to obtain a precursor; and
(3) subjecting the precursor obtained in step (2) to aging and calcination in sequence to obtain the perovskite catalyst; where
a molar ratio of the potassium nitrate, the magnesium nitrate, the calcium nitrate, and the binder in step (1) is in a range of (0.01-0.03):(0.6-1.25):(0.1-0.3):(0.1-0.75); and
the precipitation reaction in step (2) is conducted at a temperature of 50° C. to 75° C. and a pH value of 8 to 9.

In some embodiments, a ratio of a mole number of the potassium nitrate to a volume of the water in step (1) is in a range of (0.01-0.03) mol:(5.1-8.5) L.

In some embodiments, the sodium hydroxide solution in step (2) has a concentration of 0.8 mol/L to 1.2 mol/L.

In some embodiments, the sodium hydroxide solution in step (2) accounts for 5% to 10% of a volume of the mixed solution.

In some embodiments, the aging in step (3) is conducted at a temperature of 70° C. to 90° C. for 10 h to 12 h.

In some embodiments, the calcination in step (3) is conducted at a temperature of 500° C. to 600° C. for 2 h to 4 h.

The present disclosure further provides a perovskite catalyst prepared by the method described in the above technical solutions.

The present disclosure further provides use of the perovskite catalyst described in the above solutions in electromagnetic degradation of an organic waste, including: mixing the organic waste with the perovskite catalyst to obtain a mixture, and subjecting the mixture to the electromagnetic degradation in a microaerobic environment at a temperature of 200° C. to 250° C. for less than or equal to 24 h.

In some embodiments, the perovskite catalyst is added in an amount of 1% to 5% of a mass of the organic waste.

In some embodiments, the microaerobic environment has an oxygen concentration of 0.01 mL/L to 0.1 mL/L.

The present disclosure provides a method for preparing a perovskite catalyst, including the following steps: (1) mixing potassium nitrate, magnesium nitrate, calcium nitrate, and a binder with water to obtain a mixed solution; (2) mixing the mixed solution obtained in step (1) with a sodium hydroxide solution, and conducting precipitation reaction to obtain a precursor; and (3) subjecting the precursor obtained in step (2) to aging and calcination in sequence to obtain the perovskite catalyst; where a molar ratio of the potassium nitrate, the magnesium nitrate, the calcium nitrate, and the binder in step (1) is in a range of (0.01-0.03):(0.6-1.25):(0.1-0.3):(0.1-0.75); and the precipitation reaction in step (2) is conducted at a temperature of 50° C. to 75° C. and a pH value of 8 to 9. In the present disclosure, the perovskite catalyst is prepared by co-precipitation. A precursor with a higher purity is prepared by limiting types, concentrations, and addition ratios of reaction raw materials as well as controlling a temperature and a pH value of the precipitation reaction, and provides a desirable basis for the preparation of a subsequent catalyst. The precursor is subjected to aging and calcination to obtain the perovskite catalyst. The perovskite catalyst has desirable catalytic effect and could reduce activation energy of the organic waste when being mixed with the organic waste, thereby reducing a degradation temperature of the organic waste, shortening a degradation time, and avoiding the generation of dioxins. Experimental results show that using the perovskite catalyst in the electromagnetic degradation of the organic waste enables the degradation of the organic waste to be completed within 24 h at a temperature of 200° C. to 250° C.

### DETAILED DESCRIPTION OF THE EMBODIMENTS

The present disclosure provides a method for preparing a perovskite catalyst, including the following steps:
(1) mixing potassium nitrate, magnesium nitrate, calcium nitrate, and a binder with water to obtain a mixed solution;
(2) mixing the mixed solution obtained in step (1) with a sodium hydroxide solution, and conducting precipitation reaction to obtain a precursor; and
(3) subjecting the precursor obtained in step (2) to aging and calcination in sequence to obtain the perovskite catalyst; where
a molar ratio of the potassium nitrate, the magnesium nitrate, the calcium nitrate, and the binder in step (1) is in a range of (0.01-0.03):(0.6-1.25):(0.1-0.3):(0.1-0.75); and
the precipitation reaction in step (2) is conducted at a temperature of 50° C. to 75° C. and a pH value of 8 to 9.

In the present disclosure, potassium nitrate, magnesium nitrate, calcium nitrate, and a binder are mixed with water to obtain a mixed solution.

In some embodiments of the present disclosure, a molar ratio of the potassium nitrate, the magnesium nitrate, the calcium nitrate, and the binder is in a range of (0.01-0.03):(0.6-1.25):(0.1-0.3):(0.1-0.75), preferably (0.01-0.02):(0.6-1.0):(0.1-0.2):(0.1-0.5), more preferably (0.01-0.015):(0.6-0.8):(0.1-0.15):(0.1-0.3). In the present disclosure, the molar ratio of the potassium nitrate, the magnesium nitrate, the calcium nitrate, and the binder is limited to the above range, which could facilitate the preparation of a subsequent precursor and provide a desirable basis for the preparation of catalyst.

In some embodiments of the present disclosure, a ratio of a mole number of the potassium nitrate to a volume of the water is in a range of (0.01-0.03) mol:(5.1-8.5) L, preferably (0.01-0.02) mol:(5.1-8.5) L, and more preferably (0.01-0.015) mol:(5.1-8.5) L. In the present disclosure, the ratio of the mole number of the potassium nitrate to the volume of the water is limited to the above range, which could facilitate the preparation of the precursor.

In some embodiments of the present disclosure, the mixing is conducted under stirring. In some embodiments of the present disclosure, the mixing is conducted at a temperature of 50° C. to 85° C., preferably 60° C. to 70° C. In some embodiments of the present disclosure, the mixing is conducted for 5 min to 10 min, preferably 5 min to 8 min. In some embodiments of the present disclosure, the mixing is conducted at a stirring speed of 500 rpm to 800 rpm, preferably 600 rpm to 700 rpm. In the present disclosure, the mixed solution is mixed to form a viscous and transparent solution, which could facilitate the generation of the subsequent precursor.

In the present disclosure, after obtaining the mixed solution, the mixed solution is mixed with a sodium hydroxide solution and then subjected to precipitation reaction to obtain a precursor.

In some embodiments of the present disclosure, the sodium hydroxide solution has a concentration of 0.8 mol/L to 1.2 mol/L, preferably 1 mol/L. In some embodiments of the present disclosure, the sodium hydroxide solution accounts for 5% to 10%, preferably 6% to 8% of a volume of the mixed solution. In the present disclosure, the concentration and the addition amount of the sodium hydroxide solution are limited to the above range, which could ensure sufficient precipitation of magnesium ions and calcium ions in the mixed solution.

In some embodiments of the present disclosure, the precipitation reaction is conducted at a temperature of 50° C. to 75° C., preferably 60° C. to 70° C. In some embodiments of the present disclosure, the precipitation reaction is conducted at a pH value of 8 to 9, preferably 8.5. In the present disclosure, the temperature and the pH value of the precipitation reaction are limited to the above range, which could ensure co-precipitation of ions in the mixed solution and improve the uniformity of the precursor, thereby improving the catalytic performance of the catalyst.

In some embodiments of the present disclosure, the mixing of the mixed solution and the sodium hydroxide solution is conducted under stirring. In some embodiments of the present disclosure, the mixing is conducted at a stirring speed of 200 rpm to 500 rpm, preferably 300 rpm to 400 rpm. In the present disclosure, the stirring speed is limited to the above range, which could ensure mixing uniformity and sufficient precipitation reaction.

In some embodiments of the present disclosure, after the precipitation reaction is completed, a precipitate obtained by the precipitation reaction is washed to obtain the precursor.

In the present disclosure, there are no special requirements for the washing operation, and the sodium ions in the precipitation reaction may be cleaned using operations well known to those skilled in the art.

In the present disclosure, after obtaining the mixed solution, the precursor is subjected to aging and calcination in sequence to obtain a perovskite catalyst.

In some embodiments of the present disclosure, the aging is conducted at 70° C. to 90° C., preferably 80° C. In some embodiments of the present disclosure, the aging is conducted for 10 h to 12 h, preferably 11 h. In some embodiments of the present disclosure, the aging is conducted in a vacuum drying oven. There is no special limitation on a vacuum degree of the vacuum drying oven, and the vacuum degree commonly used by those skilled in the art may be used. In the present disclosure, the aging temperature and the time are limited to the above range, which could ensure that the catalyst forms a stable perovskite structure.

In some embodiments of the present disclosure, the calcination is conducted at 500° C. to 600° C., preferably 550° C. In some embodiments of the present disclosure, the calcination is conducted for 2 h to 4 h, preferably 3 h. There is no special limitation on a calcining equipment, and any calcining equipment commonly used by those skilled in the art may be used. In the present disclosure, the calcination temperature and time are set within the above range, which could ensure that the prepared catalyst has high catalytic performance.

In some embodiments of the present disclosure, after the calcination is completed, a calcined product is subjected to grinding to obtain the perovskite catalyst.

In the present disclosure, there is no special limitation on a grinding operation, and the perovskite catalyst may be ground to a particle size of 0.5 mm to 1 mm using grinding operations well known to those skilled in the art.

In the present disclosure, the perovskite catalyst is prepared by co-precipitation. A precursor with a higher purity is prepared by limiting types, concentrations, and addition ratios of reaction raw materials as well as controlling a temperature and a pH value of the precipitation reaction, and provides a desirable basis for the preparation of a subsequent catalyst. The precursor is subjected to aging and calcination to obtain the perovskite catalyst. The perovskite catalyst has desirable catalytic effect and could reduce activation energy of the organic waste when being mixed with the organic waste, thereby reducing a degradation temperature of the organic waste.

The present disclosure further provides a perovskite catalyst prepared by the preparation method described in the technical solutions.

The present disclosure further provides use of the perovskite catalyst in electromagnetic degradation of an organic waste, including: mixing the organic waste with the perovskite catalyst to obtain a mixture, and subjecting the mixture to the electromagnetic degradation in a microaerobic environment at a temperature of 200° C. to 250° C. for less than or equal to 24 h.

In some embodiments of the present disclosure, the organic waste is selected from domestic waste. In some embodiments of the present disclosure, the organic waste is one or more selected from the group consisting of plastic, paper, nylon, kitchen waste, and wood products.

In some embodiments of the present disclosure, the perovskite catalyst is added in an amount of 1% to 5%, preferably 2% to 4%, and more preferably 3% of a mass of the organic waste. In the present disclosure, the amount of perovskite catalyst is limited to the above range, which could increase the reaction speed and keep the degradation temperature of organic waste within an appropriate range.

In some embodiments of the present disclosure, the microaerobic environment has an oxygen concentration of 0.01 mL/L to 0.1 mL/L, preferably 0.05 mL/L to 0.08 mL/L. In the present disclosure, the oxygen concentration of the microaerobic environment is limited to the above range, which could ensure sufficient decomposition of the organic waste.

In some embodiments of the present disclosure, an electromagnetic field for the electromagnetic degradation is generated by an electromagnetic field generator. In some embodiments of the present disclosure, a magnetic field generated by the electromagnetic field generator is a high-frequency magnetic field. In some embodiments of the present disclosure, the high-frequency magnetic field has a magnetic field intensity of 2 T to 5 T, preferably 3 T to 4 T. In the present disclosure, the magnetic field intensity is limited to the above range, which could ensure that the electromagnetic degradation has an appropriate heating rate, and accelerate the reaction.

In the present disclosure, when a temperature of the organic material during the electromagnetic degradation reaches the temperature of the electromagnetic degradation, the electromagnetic field generator stops generating the high-frequency magnetic field; and when the temperature of the organic material is lower than the temperature of the electromagnetic degradation, the electromagnetic field generator starts automatically.

In some embodiments of the present disclosure, the electromagnetic degradation is conducted at a temperature of 200° C. to 250° C., preferably 200° C. to 240° C., more preferably 200° C. to 230° C. In some embodiments of the present disclosure, the electromagnetic degradation is conducted for less than or equal to 24 h, preferably 12 h to 24 h, more preferably 15 h to 24 h. In the present disclosure, the temperature and time of electromagnetic degradation are limited to the above range, which could avoid the generation of dioxins during the waste treatment and shorten the degradation time.

In some embodiments of the present disclosure, ash and slag generated after the electromagnetic degradation of the organic waste has an ignition loss rate of less than or equal to 3%.

In some embodiments of the present disclosure, a gas generated during the electromagnetic degradation of the organic waste is discharged after water washing and spraying, electric tar capture, and low-temperature plasma purification. In the present disclosure, the gas is purified, which could avoid environmental pollution.

In some embodiments of the present disclosure, after electromagnetic degradation of the organic waste, the perovskite catalyst is mixed with the ash and slag and discharged as the reaction proceeds, and an inorganic catalyst is recycled and reused by applying a magnetic field.

The technical solutions of the present disclosure will be clearly and completely described below with reference to the examples of the present disclosure. Apparently, the described examples are merely a part rather than all of the examples of the present disclosure. All other embodiments obtained by those skilled in the art based on the embodiments of the present disclosure without creative efforts should fall within the protection scope of the present disclosure.

### Example 1

The present example provided a method for preparing a perovskite catalyst, which was performed by the following steps:
(1) Potassium nitrate, magnesium nitrate, calcium nitrate, and a binder were mixed with water at a temperature of 60° C. and a stirring speed of 600 rpm for 5 min to obtain a mixed solution. A molar ratio of the potassium nitrate, the magnesium nitrate, the calcium nitrate, and the binder was 0.01:0.8:0.1:0.3. A ratio of a mole number of the potassium nitrate to a volume of the water was 0.01 mol: 5.5 L.
(2) The mixed solution obtained in step (1) was mixed with a 1 mol/L sodium hydroxide solution at a stirring speed of 300 rpm under stirring and then subjected to precipitation reaction at a temperature of 65° C. to obtain a precursor. The precipitation reaction was conducted at a pH value of 9. The sodium hydroxide solution accounted for 6.5% of a volume of the mixed solution.
(3) The precursor obtained in step (2) was aged in a vacuum drying oven at a temperature of 80° C. for 12 h, then calcined in a muffle furnace under vacuum at a temperature of 550° C. for 3 h, and then ground to obtain the perovskite catalyst. The perovskite catalyst had a particle size of 1 mm.

### Example 2

The present example provided a method for preparing a perovskite catalyst, which was performed by the following steps:
(1) Potassium nitrate, magnesium nitrate, calcium nitrate, and a binder were mixed with water at a temperature of 70° C. and a stirring speed of 700 rpm for 5 min to obtain a mixed solution. A molar ratio of the potassium nitrate, the magnesium nitrate, the calcium nitrate, and the binder was 0.02:0.8:0.1:0.15. A ratio of a mole number of the potassium nitrate to a volume of the water was 0.02 mol: 8.5 L.
(2) The mixed solution obtained in step (1) was mixed with a 0.9 mol/L sodium hydroxide solution at a stirring speed of 350 rpm under stirring and then subjected to precipitation reaction at a temperature of 70° C. to obtain a precursor. The precipitation reaction was conducted at a pH value of 8.5. The sodium hydroxide solution accounted for 7% of a volume of the mixed solution.
(3) The precursor obtained in step (2) was aged in a vacuum drying oven at a temperature of 80° C. for 10 h, then calcined in a muffle furnace under vacuum at a temperature of 580° C. for 3 h, and then ground to obtain the perovskite catalyst. The perovskite catalyst had a particle size of 0.8 mm.

### Example 3

The present example provided a method for preparing a perovskite catalyst, which was performed by the following steps:
(1) Potassium nitrate, magnesium nitrate, calcium nitrate, and a binder were mixed with water at a temperature of 80° C. and a stirring speed of 700 rpm for 8 min to obtain a mixed solution. A molar ratio of the potassium nitrate, the magnesium nitrate, the calcium nitrate, and the binder was 0.01:0.8:0.13:0.3. A ratio of a mole number of the potassium nitrate to a volume of the water was 0.015 mol: 7.5 L.
(2) The mixed solution obtained in step (1) was mixed with a 1.1 mol/L sodium hydroxide solution at a stirring speed of 400 rpm under stirring and then subjected to precipitation reaction at a temperature of 80° C. to obtain a precursor. The precipitation reaction was conducted at a pH value of 8.5. The sodium hydroxide solution accounted for 7.5% of a volume of the mixed solution.
(3) The precursor obtained in step (2) was aged in a vacuum drying oven at a temperature of 85° C. for 10 h, then calcined in a muffle furnace under vacuum at a temperature of 530° C. for 3 h, and then ground to obtain the perovskite catalyst. The perovskite catalyst had a particle size of 0.6 mm.

### Use Example 1

Use of the perovskite catalyst prepared in Example 1 in electromagnetic degradation of an organic waste: the organic waste was mixed with the perovskite catalyst, and then subjected to the electromagnetic degradation in a microaerobic environment with an oxygen concentration of 0.03 mL/L. The electromagnetic degradation was conducted at a temperature of 200° C. for 18 h. The perovskite catalyst was added in an amount of 2.5% of a mass of the organic waste. The organic waste was plastic, paper, and nylon. A high-frequency electromagnetic field for the electromagnetic degradation was generated by an electromagnetic field generator. The high-frequency magnetic field had a magnetic field intensity of 3 T. After a temperature of the organic material reached a temperature of 200° C. during the electromagnetic degradation, the electromagnetic field generator stopped generating the high-frequency magnetic field; when the temperature of the organic material was lower than 200° C., the electromagnetic field generator started automatically.

Ash and slag generated after the electromagnetic degradation of the organic waste has an ignition loss rate of 3%.

A gas generated during the electromagnetic degradation of the organic waste was preferably discharged after water washing and spraying, electric tar capture, and low-temperature plasma purification to reach the “Standard for pollution control on the municipal solid waste incineration” (GB 18485-2014).

After electromagnetic degradation of the organic waste, the perovskite catalyst was mixed with the ash and slag and discharged as the reaction proceeded, and an inorganic catalyst was recycled and reused by applying a magnetic field.

### Use Example 2

Use of the perovskite catalyst prepared in Example 2 in electromagnetic degradation of an organic waste: the organic waste was mixed with the perovskite catalyst, and then subjected to the electromagnetic degradation in a microaerobic environment with an oxygen concentration of 0.08 mL/L. The electromagnetic degradation was conducted at a temperature of 220° C. for 21 h. The perovskite catalyst was added in an amount of 3% of a mass of the organic waste; the organic waste was plastic and food waste. A high-frequency electromagnetic field for the electromagnetic degradation was generated by an electromagnetic field generator The high-frequency magnetic field had a magnetic field intensity of 4 T. After a temperature of the organic material reached a temperature of 220° C. during the electromagnetic degradation, the electromagnetic field generator stopped generating the high-frequency magnetic field; when the temperature of the organic material was lower than 220° C., the electromagnetic field generator started automatically.

Ash and slag generated after the electromagnetic degradation of the organic waste has an ignition loss rate of 2.8%.

A gas generated during the electromagnetic degradation of the organic waste was preferably discharged after being purified by water washing and spraying, electric tar capture, and low-temperature plasma and then reached the “Standard for pollution control on the municipal solid waste incineration” (GB 18485-2014).

After electromagnetic degradation of the organic waste, the perovskite catalyst was mixed with the ash and slag and discharged as the reaction proceeded, and an inorganic catalyst was recycled and reused by applying a magnetic field.

### Use Example 3

Use of the perovskite catalyst prepared in Example 3 in electromagnetic degradation of an organic waste: the organic waste was mixed with the perovskite catalyst, and then subjected to the electromagnetic degradation in a microaerobic environment with an oxygen concentration of 0.1 mL/L. The electromagnetic degradation was conducted at a temperature of 230° C. for 23 h. The perovskite catalyst was added in an amount of 2% of a mass of the organic waste. The organic waste included plastic, paper, food waste, wood products, and nylon. A high-frequency electromagnetic field for the electromagnetic degradation was generated by an electromagnetic field generator. The high-frequency magnetic field had a magnetic field intensity of 4.5 T. After a temperature of the organic material reached a temperature of 230° C. during the electromagnetic degradation, the electromagnetic field generator stopped generating the high-frequency magnetic field; when the temperature of the organic material was lower than 230° C., the electromagnetic field generator started automatically.

Ash and slag generated after the electromagnetic degradation of the organic waste has an ignition loss rate of 2.6%.

A gas generated during the electromagnetic degradation of the organic waste was preferably discharged after being purified by water washing and spraying, electric tar capture, and low-temperature plasma and then reached the “Standard for pollution control on the municipal solid waste incineration” (GB 18485-2014).

After electromagnetic degradation of the organic waste, the perovskite catalyst was mixed with the ash and slag and discharged as the reaction proceeded, and an inorganic catalyst was recycled and reused by applying a magnetic field.

As shown by the results of the electromagnetic degradation of the organic waste in Use Examples 1 to 3, using the perovskite catalyst provided by the present disclosure in the electromagnetic degradation of the organic waste enables the degradation temperature to be reduced, the degradation time to be shortened, the degradation of the organic waste to be completed within 24 h at a temperature of 200° C. to 250° C. during the electromagnetic degradation of the organic waste, the temperature of the electromagnetic degradation of the organic waste to be reduced, and the generation of dioxins to be avoided.

The above descriptions are merely preferred embodiments of the present disclosure. It should be noted that a person of ordinary skill in the art may further make several improvements and modifications without departing from the principle of the present disclosure, but such improvements and modifications should be deemed as falling within the protection scope of the present disclosure.

What is claimed is:

1. A method for preparing a perovskite catalyst, comprising the following steps:
(1) mixing potassium nitrate, magnesium nitrate, calcium nitrate, and a binder with water to obtain a mixed solution;
(2) mixing the mixed solution obtained in step (1) with a sodium hydroxide solution, and conducting precipitation reaction to obtain a precursor; and
(3) subjecting the precursor obtained in step (2) to aging and calcination in sequence to obtain the perovskite catalyst; wherein
a molar ratio of the potassium nitrate, the magnesium nitrate, the calcium nitrate, and the binder in step (1) is in a range of (0.01-0.03):(0.6-1.25):(0.1-0.3):(0.1-0.75); and
the precipitation reaction in step (2) is conducted at a temperature of 50° C. to 75° C. and a pH value of 8 to 9.

2. The method of claim 1, wherein a ratio of a mole number of the potassium nitrate to a volume of the water in step (1) is in a range of (0.01-0.03) mol:(5.1-8.5) L.

3. The method of claim 1, wherein the sodium hydroxide solution in step (2) has a concentration of 0.8 mol/L to 1.2 mol/L.

4. The method of claim 2, wherein the sodium hydroxide solution in step (2) accounts for 5% to 10% of a volume of the mixed solution.

5. The method of claim 1, wherein the aging in step (3) is conducted at a temperature of 70° C. to 90° C. for 10 h to 12 h.

6. The method of claim 1, wherein the calcination in step (3) is conducted at a temperature of 500° C. to 600° C. for 2 h to 4 h.

7. A perovskite catalyst prepared by the method of claim 1.

8. A method for using the perovskite catalyst of claim 7 in electromagnetic degradation of an organic waste, comprising: mixing the organic waste with the perovskite catalyst to obtain a mixture, and subjecting the mixture to the electromagnetic degradation in a microaerobic environment at a temperature of 200° C. to 250° C. for less than or equal to 24 h.

9. The method of claim 8, wherein the perovskite catalyst is added in an amount of 1% to 5% of a mass of the organic waste.

10. The method of claim 8, wherein the microaerobic environment has an oxygen concentration of 0.01 mL/L to 0.1 mL/L.

11. The method of claim 3, wherein the sodium hydroxide solution in step (2) accounts for 5% to 10% of a volume of the mixed solution.

12. The perovskite catalyst of claim 7, wherein a ratio of a mole number of the potassium nitrate to a volume of the water in step (1) is in a range of (0.01-0.03) mol:(5.1-8.5) L.

13. The perovskite catalyst of claim 7, wherein the sodium hydroxide solution in step (2) has a concentration of 0.8 mol/L to 1.2 mol/L.

14. The perovskite catalyst of claim 7, wherein the sodium hydroxide solution in step (2) accounts for 5% to 10% of a volume of the mixed solution.

15. The perovskite catalyst of claim 7, wherein the aging in step (3) is conducted at a temperature of 70° C. to 90° C. for 10 h to 12 h.

16. The perovskite catalyst of claim 7, wherein the calcination in step (3) is conducted at a temperature of 500° C. to 600° C. for 2 h to 4 h.
